(19) United States
(12) Patent Application Publication
(10) Pub. No.: US 2026/0181747 A1
(43) Pub. Date: Jun. 25, 2026

(54) METHOD FOR OPERATING AN INDUCTION COOKTOP AND INDUCTION COOKTOP

(71) Applicant: ELECTROLUX APPLIANCES AKTIEBOLAG, Stockholm (SE)

(72) Inventors: Alex VIROLI, Forli (IT); Massimo NOSTRO, Forli (IT); Fabio ANGELI, Forli (IT); Filippo MARTINI, Forli (IT)

(21) Appl. No.: 19/127,489

(22) PCT Filed: Oct. 20, 2023
(86) PCT No.: PCT/EP2023/079272

§ 371 Date: May 6, 2025

(30) Foreign Application Priority Data
Nov. 8, 2022 (EP) 22206030.3

(51) Int. Cl. H05B 6/06; H05B 6/44

(52) U.S. Cl. CPC H05B 6/062; H05B 6/065; H05B 6/44

(57) ABSTRACT

The invention relates to a method for operating an induction cooktop (1). The induction cooktop (1) comprises at least two cooking zones (4, 6). The method comprises—providing for selection by a user at least two different preprogrammed cooking schemes (B, G, F, S, W) for controlling a respective cooking zone (4, 6) according to a predefined heating course, —assigning different priority values to each cooking scheme (B, G, F, S, W), and—upon selection of a respective cooking scheme (B, G, F, S, W) for at least two cooking zones (4, 6) diverting heating power (P) to the respective cooking zones (4, 6) in dependence on the respective priority value assigned.

The invention relates to a method for operating an induction cooktop. Further, the invention relates to an induction cooktop.

Induction cooktops use inductive energy transmission by an induction coil onto a cooking ware (or: dishware) thereby introducing eddy currents within the (bottom wall of the) cooking ware, which in turn heats up the cooking ware. Usually, a user selects a power level for a cooking zone of the cooktop whereon a cooking ware has been placed. Thereby, the user has to control the cooking process personally, e.g. by reducing the power level applied in order to avoid burning of food.

Modern cooktops, as described by EP2741570B1, have functions that enable automatic control of a cooking process such as boiling. By that, there is a quite high user assistance since the user may start a cooking process and does not need to attend the food on the cooktop as closely as with a “standard” cooktop. Therefore, the user has more flexibility and/or may focus more on other tasks such as preparing other foodstuff.

It is an object of the invention to enhance user comfort with usage of cooktops.

The object is solved according to the invention by a method for operating an induction cooktop according to claim 1. Additionally, that object is solved according to the invention by an induction cooktop according to claim 9. Further expedient and in parts per se inventive embodiments and developments are laid out in the dependent claims as well as in the following description.

According to the invention the method serves for operating an induction cooktop that comprises at least two cooking zones. According to the method at least two different preprogrammed cooking schemes for controlling a respective cooking zone according to a predefined heating course are provided for selection by a user. Further, different priority values are assigned to each cooking scheme. Upon selection (by the user) of a respective cooking scheme for at least two cooking zones heating power is diverted to the respective cooking zones in dependence on the respective priority value assigned.

The induction cooktop according to the invention is preferably configured for household usage. The induction cooktop comprises at least two cooking zones and a controller for controlling respective induction heating elements of the cooking zones. The controller is configured to provide—for selection by a user—at least two different preprogrammed cooking schemes for controlling a respective cooking zone according to a predefined heating course. Further, the controller is configured to assign different priority values to each cooking scheme and to divert, upon selection of one (preferably one respective) cooking scheme for at least two of the cooking zones, heating power to the respective cooking zones in dependence on the respective priority value assigned. Thus, preferably, the controller is configured to operate the induction cooktop according to the method described here and in the following.

The inventive concept of the method and the cooktop makes it possible to distribute the heating power available for the cooktop expediently, even if only restricted power is available, e.g. through the grid.

Therefore, the method according to the invention is used most preferred with induction cooktops that have limited input power. Further, due to the expedient heating power distribution, a faster and/or more effortless (and thus more comfortable) cooking process in enabled.

In particular, the method and the cooktop share respective features, be it physically or in form of method steps (which would be performed by the controller, preferably). Therefore, the method and the cooktop share also the same advantages.

According to a preferred embodiment, the cooktop comprises a user interface operably connected to the controller for user communication with the controller.

In a preferred embodiment, the controller is formed, at least in its core, by a microcontroller with a processor and a data memory in which the functionality for carrying out the method according to the invention is implemented programmatically in the form of operating software (firmware), so that the method is carried out automatically-if necessary in interaction with the user-when the operating software is executed in the microcontroller. Within the scope of the invention, however, the controller can alternatively also be formed by a non-programmable electronic component, for example an ASIC, in which the functionality for carrying out the method according to the invention is implemented by circuit means.

Preferably, the cooktop is configured to have a limited input power of less than 6 kw, especially of a maximum of 4 or less than 4 kW (e.g. of 3.6 KW). That is beneficial for countries where the grid offers only such low power withdrawal.

According to an expedient variant of the method a power limit that limits the heating power diverted to the respective cooking zone to which the cooking scheme with a higher priority value has been assigned is set to a predefined higher power limit value. That higher power limit value is higher in comparison to the power limit value assigned the cooking zone, for which the cooking scheme with a lower priority value has been selected. Thus, the cooking zone to which the cooking scheme of higher priority has been assigned receives (or at least is allowed to receive) more heating power than the at least one cooking zone being assigned with a cooking scheme of lower priority. By that, the cooktop is enabled to divert more heating power to the cooking zone with topically higher priority so that the respective cooking scheme may be carried out more easily or quicker than the other.

According to a further expedient variant of the method the power limit limiting the heating power diverted to the cooking zone to which the cooking scheme with the higher priority value has been assigned is reduced from the higher power limit value to a predefined lower power limit value, when a power demand of the heating course of the assigned cooking scheme falls beneath a predefined switching value. In other words, when the heating course of the higher priority cooking scheme does not need high heating power anymore, the power limit for the respective cooking zone is reduced to the lower power limit value. By that, heating power, specifically grid power available at the cooktop, becomes available for other cooking schemes and/or other cooking zones.

According to an optional variant of the above expedient variant, the demand of heating power during the respective heating course may be connected to a predefined time (duration) of a specific phase of the heating course (e. g. heat up). Expediently, the demand of heating power is (optionally additionally to the above time control) monitored by sensors. E.g. (for a boiling cooking scheme) a boiling up of the respective food (e.g. water, sauce or the like) is detected by optical sensors or by motion sensors (which detect vibrations caused by boiling food). Usually, when food is brought to boil heating power may be reduced by a certain amount without the food cooling beneath its boiling temperature. In that case-if boiling is assigned with priority 1—an as quick as possible boiling up of the food is enabled.

According to yet a further expedient variant of the method the power limit assigned to the cooking zone, to which the cooking scheme with a lower priority value has been assigned, is raised to the predefined higher power limit value, when the power limit of the other cooking zone (which was assigned with the higher priority cooking scheme) has been reduced from the higher power limit value to the lower (due to its fallen demand on heating power).

Thus, the concept according to the invention enables some kind of alternating play between the different cooking zones and the respective cooking schemes such that an automatic and as fast as possible heating course for the whole cooking process may be realized—even for cooktops with a restricted input power from the grid side.

According to a preferred variant of the method a fallback priority value is assigned to the respective cooking zones. That fallback priority value is used (i.e. taken into account) in situations where cooking schemes with equal priority values have been selected by the user. Generally, that fallback priority value may be assigned according to a first come first served scheme (also referred to as first in first out or “fifo”). In other words, the higher priority fallback value is assigned to the cooking scheme of the respective cooking zone which has been selected first by the user. Alternatively, the fallback priority value is chosen (assigned) in dependence on the geometric position of the cooking scheme on the cooktop. In other words, the fallback priority depends on the cooking zone to which the cooking schemes have been assigned. For example, the higher fallback priority value is always assigned to the cooking zone on the left (from the view of the user), to the one with a bigger cooking area, to the one on which a bigger cookware has been placed or the like.

According to an expedient variant of the method the higher power limit value and the lower power limit value are chosen such that these add up to a maximum operating power value (or: input power value) available for the induction cooktop. By that, no power withdrawal too high for the grid can arise.

Expediently, the higher and lower power limit values are restricted to comprise only one time the higher power limit value and one or more lower power limit values. E.g. if there are more than two cooking zones and if these are operated in parallel with respective cooking schemes, only one cooking scheme or cooking zone, respectively, is assigned with the higher power limit value and the other with the lower power limit value. In that case, all power limit values add up to the maximum operating power value.

According to a further expedient variant of the method the higher power limit value is chosen to be within about 0.55 to 0.66% of the maximum available operating power value, and/or wherein the lower power limit value is chosen to be within about 0.45 and 0.35% of the maximum available operating power value, e. g, wherein the higher power limit value is 2 KW and the lower power limit value is 1.6 KW if the maximum available operating power value is 3.6 kW. In the case of three power limit values, the power distribution may also be 50% for the higher power limit value and 25% each for the lower power limit values.

According to a preferred variant of the method the priority value assigned to a boiling cooking scheme is 1, the one assigned to a grilling cooking scheme is 2, the one assigned to a frying cooking scheme is 3, the one to a slow cooking cooking scheme is 4 and the one assigned to a keeping warm cooking scheme is 5. Expediently, as a further restriction, the cooking schemes of slow cooking and of keeping warm may only be assigned with the lower power limit value. The latter is beneficial since these cooking schemes usually do not require heating power higher than the usual lower power limit value.

The conjunction “and/or” is to be understood here and in the following in particular in such a way that the features linked by means of this conjunction can be formed both together and as alternatives to each other.

In the following, an embodiment of the invention is explained in more detail with reference to a drawing. Therein show:

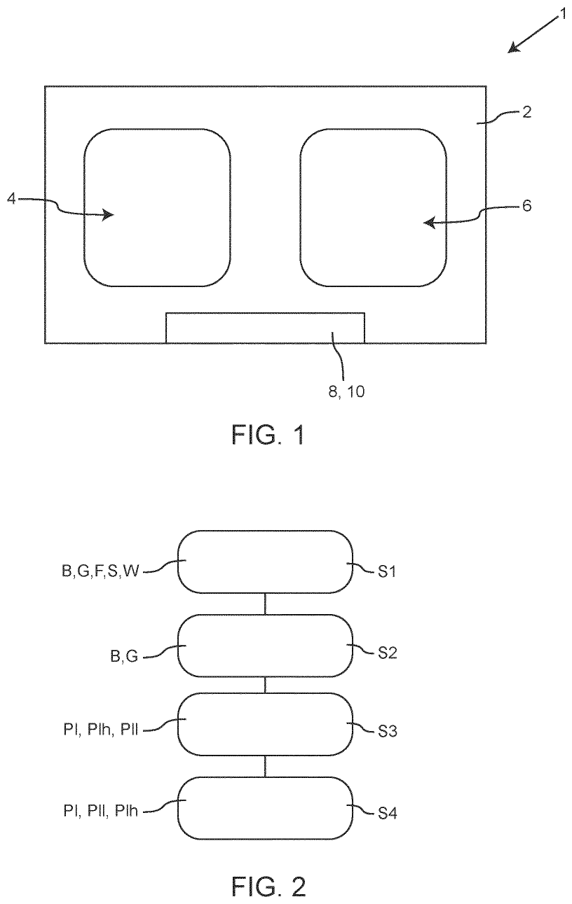

FIG. 1 in a schematic view from the above an induction cooktop,

FIG. 2 in a schematic flowchart a method carried out by a controller of the cooktop, and

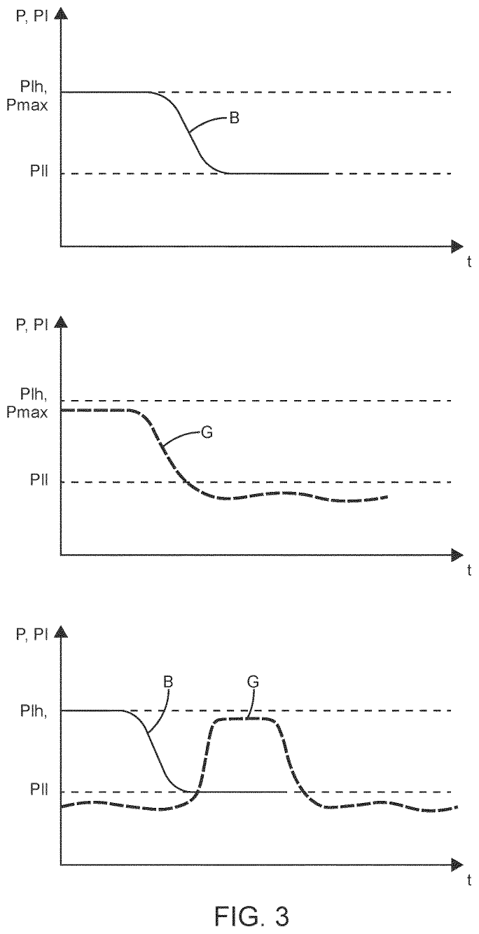

FIG. 3 by schematic diagrams of power over time three different heating courses of automatic cooking schemes during respective operation of the controller.

Parts and measures corresponding to one another are always provided with the same reference signs in all figures.

FIG. 1 shows an induction cooktop 1. The induction cooktop 1 is intended for household usage. The induction cooktop 1 comprises a cover plate 2 made of glass ceramics. Further, the induction cooktop 1 comprises two cooking zones 4 and 6 which in turn comprise, according to the embodiment shown, a respective induction coil (not shown) resembling a heating element. Additionally, the induction cooktop 1 comprises a controller 8 configured to control heating power delivered to the respective induction coils. The controller 8 is connected to a user interface 10 which in the present embodiment is resembled by a touch sensitive area of the cover plate 2. Additionally, the controller 8 is connected to a mains connection (not shown) to receive input power and deliver it as heating power P to the respective induction coil.

The induction cooktop 1 is, however, configured to be operated under restricted mains input power of 3.6 KW (i.e. the grid does not enable to withdraw a higher power value). Further, the induction cooktop 1 is configured to, especially via respective programming of the controller 8, provide automatic cooking schemes for selection by a user via the user interface 10. The cooking schemes comprise respective predefined heating courses that are intended to lead to desired cooking results of respective food items.

Two cooking schemes used in the following for description of the inventive concept are boiling B and grilling G. FIG. 3 shows in its upper and middle diagrams schematically a respective heating course (in particular, heating power P over time t) for boiling B and grilling G which is controlled by the controller 8 by providing respective heating power P to the cooking zone 4 or 6, whichever is used for the respective cooking scheme.

As long as only one cooking scheme is used for only one of the two cooking zones 4 or 6 (and the respective other cooking zone 6 or 4 is not in use), the controller 8 sets a power limit Pl for the respective cooking zone 4 or 6 to a higher power limit value Plh. For the sake of clarity, in the following, cooking zone 4 is addressed as the one used for the selected cooking scheme. Since there is only the cooking zone 4 active, the other cooking zone 6 being not in use, the higher power limit value Plh is set to the maximum available heating power Pmax (which usually would correspond to the available mains power), in the course of the topical embodiment 3.6 kW.

Thus, in the case of boiling B the controller 8 would provide heating power P at the higher power limit value Plh to the cooking zone 4. Additionally, the controller 8 would monitor the heating up of the ingredients of the cookware placed on the cooking zone 4. According to one embodiment, the controller 8 is connected to a vibration sensor (not shown) in contact with the cover plate 2. If there are vibrations of the cover plate 2 that are considered characteristic for boiling food (e. g. derived by a signal comparison) the controller 8 reduces the power limit Pl to a lower power limit value Pll that is high enough for holding the temperature of the ingredients within the cookware. Alternatively, the controller 8 may be connected with an optical (e.g. infrared) temperature sensor which could be positioned overhead of the cooktop 1, e. g. at an overhead extraction hood, and configured to monitor the cover plate 2 as well as cookware placed on the cover plate 2.

As shown in the middle diagram of FIG. 3, the cooking scheme grilling G is assigned also only to the cooking zone 4. The controller 8 would, therefore, deliver the heating power P according to the embodiment described above. However, the topical value of the heating power P forwarded by the controller 8 would be lower than the higher power limit Plh, since that is still enough for the grilling G. Having reached e.g. a predefined duration at the provided higher power level, or alternatively having reached a desired temperature, the heating power P is again reduced in order to hold temperature, e. g. to allow the grilled food item to rest.

In the case that both cooking zones 4 and 6 should be used, cooking zone 4 with boiling B and cooking zone 6 with grilling G, the controller 8 carries out a method that will be described in more detail by FIG. 2 and FIG. 3, the bottom diagram.

According to a first method step S1 the controller 8 provides several cooking schemes with predefined heating courses. Besides the already named boiling B and grilling B cooking schemes, the controller 8 also provides frying F, slow cooking S and holding warm W. For each of the cooking schemes the controller 8 also provides a priority value. For boiling B, grilling G, frying F, slow cooking S and holding warm W the priority values are 1 to 5 in corresponding order of introduction. The cooking schemes are selectable by the user via the user interface 10 for each of the two cooking zones 4 and 6. In the case, the user choses for both cooking zones 4 and 6 grilling G and, thus, the same priority value, the controller 8 provides and activates a fallback priority value, that gives the cooking schemes assigned to the cooking zone 4 the higher priority.

Within a second method step S2 two cooking schemes are selected by the user, here boiling B for the cooking zone 4 and grilling G for the cooking zone 6. The selection is registered by the controller 8 via the user interface 10.

In a third method step S3, the controller 8 sets the power limit Pl of the cooking zone 4 to the higher power limit value Plh since cooking zone 4 has been chosen for boiling B having the highest priority value. However, since two cooking schemes are to be carried out in parallel, the higher power limit value Plh is set to 2 kW (being about 55% of the maximum available power of 3.6 KW). The power limit Pl for the cooking zone 6 (being selected for grilling G with a lower priority value) is set to the lower power limit value Pll, especially to 1.6 kw. Due to that, cooking zone 4 may power up and heat up as much and quick as possible wherein cooking zone 6 is allowed to heat up only to a restricted amount.

The controller 8 monitors whether the ingredients of the cookware placed on cooking zone 4 begin to boil. If boiling is detected (compare description above), within a fourth method step S4, the controller 8 takes that as a power demand of boiling B falling beneath a respective switching value and, thus, reduces the power limit Pl of cooking zone 4 to the lower power limit value Pll. At the same step, the controller 8 sets the power limit Pl of cooking zone 6 to the higher power limit value Plh. Thus, cooking zone 4 still receives heating power P so that the ingredients may be kept on boiling. The cooking zone 6 is allowed to heat up and start with the normal heating course of grilling G, only with an automated time delay.

As described above, the controller 8 also monitors the status of the ingredients of the cookware placed on cooking zone 6, e. g. by monitoring a grilling duration and/or a temperature of the ingredients. After the respective criterions (e. g. the duration and/or the temperature) are met, the controller 8 reduces the power limit Pl for cooking zone 6 (again) to the lower power limit value Pll. After a predetermined duration at the lower power limit value Pll, the cooking schemes of both cooking zones 4 and 6 are ended, preferably with an indication to the user.

The subject matter of the invention is not limited to the above-described embodiment. Rather, further embodiments of the invention can be derived by the skilled person from the above description.

List of reference signs

| | |
|---|---|
| 1 | cooktop |
| 2 | cover plate |
| 4 | cooking zone |
| 6 | cooking zone |
| 8 | controller |
| 10 | user interface |
| B | boiling |
| G | grilling |
| F | frying |
| S | slow cooking |
| W | keeping warm |
| P | heating power |
| Pl | power limit |
| Plh | higher power limit value |
| Pll | lower power limit value |
| Pmax | maximum available heating power |

1. A method for operating an induction cooktop comprising a plurality of cooking zones, the method comprising:
providing for selection by a user a plurality of preprogrammed cooking schemes that are different from each other, each preprogrammed cooking scheme being configured for controlling at least one cooking zone of the plurality of cooking zones according to a predefined heating course,
assigning respective priority values to the plurality of preprogrammed cooking schemes, wherein the respective priority values are different from each other, and
upon selection of a preprogrammed cooking scheme from the plurality of preprogrammed cooking schemes for one or more cooking zones of the plurality of cooking zones, diverting heating power to the one or more cooking zones in dependence on the respective priority value assigned to the selected preprogrammed cooking scheme.

2. The method according to claim 1, wherein:
a first preprogrammed cooking scheme is selected from the plurality of preprogrammed cooking schemes for a first cooking zone of the plurality of cooking zones, and
a second preprogrammed cooking scheme is selected from the plurality of preprogrammed cooking schemes for a second cooking zone of the plurality of cooking zones, wherein the first preprogrammed cooking scheme has a higher priority value than the second preprogrammed cooking scheme,
a first power limit limiting heating power diverted to the first cooking zone is set to a first predefined power limit value, and
a second power limit limiting heating power diverted to the second cooking zone is set to a second predefined power limit value, wherein the first predefined power limit value is higher than the second predefined power limit value.

3. The method according to claim 2, wherein the first power limit limiting heating power diverted to the first cooking zone, to which the first preprogrammed cooking scheme with the higher priority value has been assigned, is reduced from the first predefined power limit value to a lower predefined power limit value, when a power demand of a heating course of the first preprogrammed cooking scheme falls beneath a predefined switching value.

4. The method according to claim 3, wherein the second power limit limiting heating power diverted to the second cooking zone, to which the second preprogrammed cooking scheme with a lower priority value has been assigned, is raised to the first predefined power limit value, when the first power limit limiting heating power diverted to the first cooking zone is reduced to the lower predefined power limit value.

5. The method according to claim 1, wherein:
respective fallback priority values are assigned to the plurality of cooking zones in dependence of the geometric positions of the plurality of cooking zones on the induction cooktop, and
the respective fallback priority values for at least two cooking zones of the plurality of cooking zones are taken into account when the priority values for the at least two cooking zones are equal.

6. The method according to claim 2, wherein the first predefined power limit value and the second predefined power limit value add up to a maximum operating power value available for the induction cooktop.

7. The method according to claim 2, wherein the first predefined power limit value is restricted such that only one cooking zone of the plurality of cooking zones is set to the first predefined power limit value if two or more cooking zones are operated in parallel.

8. The method according to claim 2, wherein the first predefined power limit value is within about 55% to about 66% of a maximum available operating power value for the induction cooktop, and/or wherein the second predefined power limit value is within about 35% to about 45% of the maximum available operating power value.

9. An induction cooktop comprising:
a plurality of cooking zones, and
a controller configured to:
provide for selection by a user a plurality of preprogrammed cooking schemes that are different from each other, each preprogrammed cooking scheme being configured for controlling at least one cooking zone of the plurality of cooking zones according to a predefined heating course,
assign respective priority values to the plurality of preprogrammed cooking schemes, wherein the respective priority values are different from each other, and
upon selection of a preprogrammed cooking scheme from the plurality of preprogrammed cooking schemes for one or more cooking zones, divert heating power to the one or more cooking zones in dependence on the respective priority value assigned to the selected preprogrammed cooking scheme.

10. The induction cooktop according to claim 9, comprising a user interface operably connected to the controller for user communication with the controller.

11. The induction cooktop according to claim 9, wherein:
the plurality of preprogrammed cooking schemes includes a boiling cooking scheme, a grilling cooking scheme, a frying cooking scheme, a slow-cooking cooking scheme, and keeping warm cooking scheme, and
the controller is configured to assign to the boiling cooking scheme a priority value of 1, the grilling cooking scheme a priority value of 2, the frying cooking scheme a priority value of 3, the slow-cooking cooking scheme a priority value of 4, and the keeping warm cooking scheme a priority value of 5.

12. The induction cooktop according to claim 9, wherein when a first preprogrammed cooking scheme is selected from the plurality of preprogrammed cooking schemes for a first cooking zone of the plurality of cooking zones, and a second preprogrammed cooking scheme is selected from the plurality of preprogrammed cooking schemes for a second cooking zone of the plurality of cooking zones, first preprogrammed cooking scheme having a higher priority value than the second preprogrammed cooking scheme, the controller is configured to:
set a first power limit limiting heating power diverted to the first cooking zone to a first predefined power limit value, and
set a second power limit limiting heating power diverted to the second cooking zone to a second predefined power limit value, wherein the first predefined power limit value is higher than the second predefined power limit value.

13. The induction cooktop according to claim 12, wherein the controller is configured to reduce the first power limit limiting heating power diverted to the first cooking zone from the first predefined power limit value to a lower predefined power limit value, when a power demand of a heating course of the first preprogrammed cooking scheme falls beneath a predefined switching value.

14. The induction cooktop according to claim 13, wherein the controller is configured to raise the second power limit limiting heating power diverted to the second cooking zone to the first predefined power limit value, when the first power limit limiting heating power diverted to the first cooking zone is reduced to the lower predefined power limit value.

15. The induction cooktop according to claim 12, wherein the first predefined power limit value and the second predefined power limit value add up to a maximum operating power value available for the induction cooktop.

16. The induction cooktop according to claim 12, wherein the controller is configured to restrict first predefined power limit value such that only one cooking zone of the plurality of cooking zones is set to the first predefined power limit value if two or more cooking zones are operated in parallel.

17. The induction cooktop according to claim 12, wherein the first predefined power limit value is within about 55% to about 66% of a maximum available operating power value for the induction cooktop, and/or wherein the second predefined power limit value is within about 35% to about 45% of the maximum available operating power value.

18. The induction cooktop according to claim 9, wherein the controller is configured to:
assign respective fallback priority values to the plurality of cooking zones in dependence of the geometric positions of the plurality of cooking zones on the induction cooktop, and
take into account the respective fallback priority values for at least two cooking zones of the plurality of cooking zones when the priority values for the at least two cooking zones are equal.

19. The method according to claim 1, wherein:
the plurality of preprogrammed cooking schemes includes a boiling cooking scheme, a grilling cooking scheme, a frying cooking scheme, a slow-cooking cooking scheme, and keeping warm cooking scheme, and
the boiling cooking scheme is assigned a priority value of 1, the grilling cooking scheme is assigned a priority value of 2, the frying cooking scheme is assigned a priority value of 3, the slow-cooking cooking scheme is assigned a priority value of 4, and the keeping warm cooking scheme is assigned a priority value of 5.

20. A method for operating an induction cooktop comprising a plurality of cooking zones, the method comprising:
providing for selection by a user a first preprogrammed cooking scheme and a second preprogrammed cooking scheme that is different from the first preprogrammed cooking scheme, wherein the first preprogrammed cooking scheme and second preprogrammed cooking scheme are each configured for controlling at least one cooking zone of the plurality of cooking zones according to a predefined heating course;
assigning a first priority value to the first preprogrammed cooking scheme and a second priority value to the second preprogrammed cooking scheme, wherein the first priority value is higher than the second priority value;
selecting the first preprogrammed cooking scheme from the plurality of preprogrammed cooking schemes for a first cooking zone of the plurality of cooking zones, and diverting heating power to the first cooking zone in dependence on the first priority value assigned to the first preprogrammed cooking scheme; and
selecting the second preprogrammed cooking scheme from the plurality of preprogrammed cooking schemes for a second cooking zone of the plurality of cooking zones, and diverting heating power to the second cooking zone in dependence on the second priority value assigned to the second preprogrammed cooking scheme,
wherein a first power limit limiting heating power diverted to the first cooking zone is set to a first predefined power limit value, and
wherein a second power limit limiting heating power diverted to the second cooking zone is set to a second predefined power limit value, wherein the first predefined power limit value is higher than the second predefined power limit value.
